(19) United States
(12) Patent Application Publication
(10) Pub. No.: US 2003/0069792 A1
(43) Pub. Date: Apr. 10, 2003

(54) System and method for effecting secure online payment using a client payment card

(75) Inventor: Henrik Blumenthal, Helsinki (FI)

Correspondence Address: COHEN, PONTANI, LIEBERMAN & PAVANE, 551 Fifth Avenue, Suite 1210, New York, NY, 10176, US

(73) Assignee: Smarttrust Systems Oy

(21) Appl. No.: 10/201,182

(22) Filed: Jul. 22, 2002

Related U.S. Application Data
(63) Continuation of application No. PCT/FI01/00063, filed on Jan. 24, 2001.

(30) Foreign Application Priority Data
Jan. 24, 2000 (FI) 20000135

(51) Int. Cl. G06F 17/60

(52) U.S. Cl. 705/16

(57) ABSTRACT

Payment using a payment card for goods and/or services ordered online via an information network such as the Internet is implemented in a notably secure manner without the need to transmit the client's payment card number over the data transmission network. A separate confirmation for effecting the payment for an order is requested from the client. The information to be confirmed is transmitted to the terminal device of the client, such as a mobile station, by means of which the client confirms the order by digitally signing the confirmation request. The digitally signed confirmation and the electronic identity information associated with the client are then returned to the payment service equipment, which verifies the client's identity, checks the validity of the client's payment card, and then transmits the necessary payment information to the payment system.

### BACKGROUND OF THE INVENTION

1. Field of the Invention

The present invention relates to telecommunication systems and, in particular, to payment service equipment and methods for providing improved secure use of a payment card such as a credit card for effecting an online payment transaction.

2. Description of Related Art

In a traditional payment transaction, the client visits the offices or retail site of a merchant, chooses desired products from the shelves and, thereafter, pays for his or her purchases, as for example with cash or using a bank or credit card. In addition to such traditional commerce, it is known to purchase and pay for goods or trade or a variety of services via a multiplicity of telecommunication networks. In a mobile communication network, such as the GSM (Global System for Mobile communications) system, a variety of different purchases can be effected and paid for on-line using one's mobile station. The mobile station may also be used to digitally sign and/or encrypt outgoing traffic for various operating applications, which helps to improve data security in appropriate situations. The so-called public key infrastructure, or PKI, is commonly employed when implementing encryption and digital signing.

In the public key infrastructure, a user is provided with two keys, a public key and a private key. When the user wishes to send encrypted information to another, he or she encrypts the information using the intended recipient's public key. The information thus encrypted with the recipient's public key can thereafter only be transformed into a readable form—i.e. decrypted—by using the recipient's private key that is associated with the public key used to effect the encryption. A digital signature is implemented in the opposite manner: the sender signs the message using his or her private signing key, and the recipient may in turn decode the message into a readable form only by using the sender's public signing key that is associated with the sender's private signing key. Digital signing thus enables a recipient to confirm that the purported sender really is the person that he or she claims to be.

Payment for goods and services via the Internet has been possible for a significant period of time. In typical practice a client visits the World Wide Web (WWW) site of a merchant or other service provider, chooses desired products (or services) for purchase, and effects payment for the selected products. One way to effect payment is by transmitting the purchaser's credit card number directly to the merchant, over the Internet, without encryption. This alternative does not, however, provide any way of assuring that the payment is effected in a secure manner.

Several different electronic payment mechanisms or modes for use in conjunction with the Internet have been developed. At present these include, by way of illustrative example, Ecash, solo of the Merita Bank, Kultaraha of the bank Osuuspankki, and the SET (Secure Electronic Transaction) protocol and system of credit card companies. SET is an international payment system jointly developed by VISA and MasterCard for secure purchasing on the Internet, and is based on certificates issued by a trusted third party and the encrypted transmission of information. SET uses symmetric and asymmetric encryption, digital signature, and an SHA-1 algorithm (Secure Hash Algorithm). The SET protocol and procedure is intended to provide the advantages of information encryption, confidentiality, checking of the integrity of information, authentication of the sender, and indisputability.

The term symmetric encryption is intended herein to denote an encryption method in which the encrypted message may be decoded using the same key with which the message was encrypted; DES (Data Encryption Standard) is one example of a symmetric encryption method. Asymmetric encryption is intended herein to denote a method in which the message is encrypted and decoded using different keys, as for example in the public key RSA (Rivest, Shamir, Adleman) method.

There exist several problems in the use of current practices for the purchase of goods and services via the Internet. For example, the payment systems supporting bank or credit or other payment cards are often card-specific, so that typically the same enabling applications cannot be used for effecting payment with credit cards issued by another company. The commercial centres are accordingly required to concurrently support the payment practices of a multiplicity of different systems.

In order to improve the security aspects of effecting payment with a credit card, all of the parties associated with the payment transaction—both the client and the merchant—must often make investments in reliable software. Where the investments required are too great, at least one of the parties may not make that investment, thereby creating an obstacle to increases and the widespread use of commercial transactions effected via the network.

There also exist methods in which both of the parties to a commercial transaction, i.e. the client and the merchant, possess their own certificates. As used herein, the term certificate is intended to denote a kind of identification information that has been issued by a trusted third party (TTP). In effecting a credit card payment, the certificate indicates that the user's credit card is valid for making the payment. A certificate issued to the merchant provides, in turn, proof that the merchant is an authorized merchant. Thus, through the use of certificates both the client and the merchant can confirm the identity of the other. Certificates, digital signatures and encryption can thereby notably enhance the available security in effecting payment with a credit card via the Internet.

Currently known and employed modes and methods of online credit card payment nevertheless have significant weaknesses. The complexity of the payment system and the heavy investments required to establish the necessary infrastructure have already been discussed. The biggest problem, however, is the fact that the credit card number of the client is transmitted over the data transmission network. In addition, some known methods require use of a so-called digital wallet that includes client-specific information, as for example the user's certificate, credit card number, validity of the card, etc. Thus, some systems require that such a digital wallet be present in the terminal device from which the client is attempting the purchase in order to effect or complete a successful payment transaction.

### OBJECTS AND SUMMARY OF THE INVENTION

It is accordingly the desideratum of the present invention to eliminate, or at least significantly alleviate, the drawbacks and deficiencies of current and prior art systems and methods, as for example those discussed hereinabove.

It is a particular object of the invention to provide a new type of payment service apparatus and method which enables the ability to securely pay with a payment card, such as a credit card, in or via an information network such as the Internet. Advantageously, in implementing this objective the credit card number of the client is never transmitted over the data transmission network, and the identity of the particular issuer of the card is irrelevant as the inventive method functions irrespective of the particular card being employed to effect payment.

The present invention is specifically directed, in its most preferred implementations, to improving the security available in a payment transaction that is effected using a payment card via the Internet. The payment service apparatus or arrangement and methods in accordance with the invention enable the client to pay for desired products or services using the client's payment card via the Internet without having to transmit the credit card number over the telecommunication network. In addition, the inventive methods are not bound or restricted to the use of a payment card issued by any particular company or computer.

The payment service equipment or apparatus of the invention comprises a first access interface to the payment system, a second access interface to the authentication system and a third access interface to the telecommunication network. The payment service equipment further comprises a certificate database for storing the certificates associated with clients, a service provider database for storing information relating to registered service providers, a client database for storing information relating to clients, a transaction database for storing information relating to payment transactions, and a verification database that includes an auxiliary list of suspicious payment cards.

In accordance with the invention, the client database contains, by way of example, the mobile communications number of the client and information relating to the client's payment card which, for ease of discussion, is illustratively assumed to be a credit card. The client's payment card information may also be included also as a part of the certificate associated with the client.

The payment service equipment further comprises a generation block for generating a billing ticket connected with each payment transaction, a telecommunication block for sending and receiving a confirmation of purchase associated with each billing ticket, an identification block for identifying the particular client based on his or her electronic identity and signature, and an information retrieval block for checking the credit card information of the client.

The information included in the client database and service provider database may be encrypted, as by using a public key of the service payment equipment.

In one embodiment of the invention, the service payment equipment further comprises a fourth access interface to the mobile communication network.

The present invention is also directed to a method for effecting secure payment in a telecommunication system that includes a mobile communication network, a telecommunication network, a payment terminal device that includes a smart card and that is connected to the mobile communication network or to the telecommunication network, a trusted third party, a payment system, a service provider, and an authentication system. In the inventive method, a certificate associated with the client is generated and issued by the trusted third party, the product or service to be ordered is selected by the client via the service provider by means of a display terminal device through the telecommunication and/or mobile communication network, and the client's payment card and/or payment card information is used to pay for the product or service ordered.

In accordance with the invention, the payment service equipment is used to generate a billing ticket. A confirmation of order is sent to the payment terminal device, illustratively implemented by a mobile station, of the client via the mobile communication network. A smart card, such as a subscriber identity module (SIM) is present in or inserted into the mobile station. The confirmation of order is signed and/or encrypted in the payment terminal device, the signing and/or encryption being carried out by means of the smart card. Stored on the smart card are the necessary keys for effecting the signing and/or encryption, and the smart card may also, in preferred implementations, store or contain the electronic identity of the client, the private key associated with the client, and the public key associated with the payment service apparatus.

The signed and/or encrypted confirmation of order and the electronic identity associated with the client are transmitted from the payment terminal device to the payment service apparatus via the mobile communication network. The client is identified by the payment service apparatus based on the electronic identity, as for example by reference to the information included in the certificate database. The payment card number associated with the client is retrieved and the right of use of the payment card is verified; payment is then accepted upon a successful verification. Before accepting the payment the verification database of or attached to the payment service apparatus may be checked to verify that the client's payment card is not among those listed in the database as suspicious or forbidden for use. The request for debiting of the payment from the appropriate account or the like is then further transferred for implementation in the payment system.

Checking of the validity of the payment card may be carried out, by way of illustration, in a separate authentication system. For this purpose the payment card information associated with the client is retrieved, as from the database of the payment service apparatus. In one embodiment of the invention, the payment card number of the client is retrieved from a certificate database attached to or associated with the payment service apparatus. The payment card may by way of example be a Visa, MasterCard, Diners Club, or bank card.

Once the requested use of the client's payment card has been accepted, the service provider may be sent a confirmation of the fact that the payment associated with the order has been effected. A similar confirmation may also be sent to the display terminal device or payment terminal device of the client.

In implementing the invention, the payment terminal device and display terminal device may comprise a mobile station that incorporates both facilities. In other implementations the payment terminal device may be a mobile station and the display terminal device may be a computer, such as a conventional personal computer or the like.

In some embodiments of the invention, the trusted third party updates the certificate database. The trusted third party may for example be a certificate authority (CA).

In various embodiments of the invention, the mobile communication network may be a mobile communication network consistent with the GSM system, and/or the telecommunication network may be a packet-switched network such as the Internet.

The present invention also provides a method for effecting secure payment in a telecommunication system that includes a telecommunication network, a terminal device connected to the telecommunication network and having an integral or associated card reader for receiving a smart card, a trusted third party, a payment system, a service provider and an authentication system. In accordance with the inventive method, the trusted third party generates and issues a certificate associated with the client, the product or service to be ordered is selected from the service provider by means of the terminal device via the telecommunication network, and the client's payment card and/or payment card information is used to pay for the selected product or service.

In further accordance with the invention, the payment service apparatus is used to generate a billing ticket. A confirmation of the client's order is transmitted to the terminal device of the client via the telecommunication network; that terminal device may for example comprise a computer. The confirmation of order is digitally signed and/or encrypted by means of the terminal device, and the signing and/or encryption is enabled by way of the card reader attached to the terminal device and the smart card inserted into the reader. Thus, the client places in the card reader his or her smart card on which are stored the necessary keys for carrying out the signing and/or encryption. The data stored on the smart card preferably includes the electronic identity of the client, the private key associated with the client and the public key associated with the payment service apparatus.

The digitally signed and/or encrypted confirmation of order and the electronic identity associated with the client are transmitted from the payment terminal device to the payment service equipment via the telecommunication network. The client is identified by the payment service apparatus based on the signature and/or electronic identity, as for example using the information included in the certificate database. The payment card number associated with the client is retrieved and the right to use the payment card is verified. The payment is then accepted if the payment card verification was successful. Prior to accepting the payment it may first be confirmed, in the verification database attached to the payment service apparatus, that the client's payment card is not among those listed as suspicious or forbidden for use. The request for debiting of the payment is further forwarded for implementation in the payment system.

The validity of the payment card is advantageously checked in a separate authentication system, for which purpose the payment card information associated with the client is retrieved, as from the database of the payment service apparatus. In one embodiment of the invention, the payment card number of the client is retrieved from the certificate database of or attached to the payment service apparatus; the payment card may by way of example be a Visa, MasterCard, Diners Club, or bank card.

When the attempted use of the client's payment card has been accepted, the service provider may be sent a confirmation that the payment associated with the order has been effected. A similar confirmation may also be sent to the terminal device of the client.

In embodiments of the invention in which the trusted third party updates the certificate database, the trusted third party may be a certificate authority (CA).

The telecommunication network, in various embodiments of the invention, may be a packet-switched network such as the Internet.

The present invention provides a number of advantages as compared with prior art systems and methods. Information transferred in or via an open telecommunication network in practicing the invention does not include the actual piece of information connected with the process or act of debiting. Thus, when the client pays for his or her purchases with a credit card, the credit card number is not transmitted over the telecommunication network, as a result of which the level of security presented by the inventive method is remarkably high.

In addition, the methods and apparatus of the present invention are not limited or restricted to the use of specific payment modes or systems, and can therefore be employed in all payment modes.

An additional advantage of the invention is that it does not require that the parties to a payment transaction make any large or significant investments in hardware or software to attain the benefits of improved security and ease of implementation and use that the invention inherently provides.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference numerals and characters denote similar elements and method steps through the various figures:

FIG. 1 diagrammatically depicts a first embodiment of the inventive system;

FIG. 2 diagrammatically depicts a second embodiment of the inventive system;

FIG. 3 is a signalling flow chart in accordance with the invention; and

FIG. 4 is another signalling flow chart in accordance with the invention.

### DETAILED DESCRIPTION OF THE CURRENTLY PREFERRED EMBODIMENTS

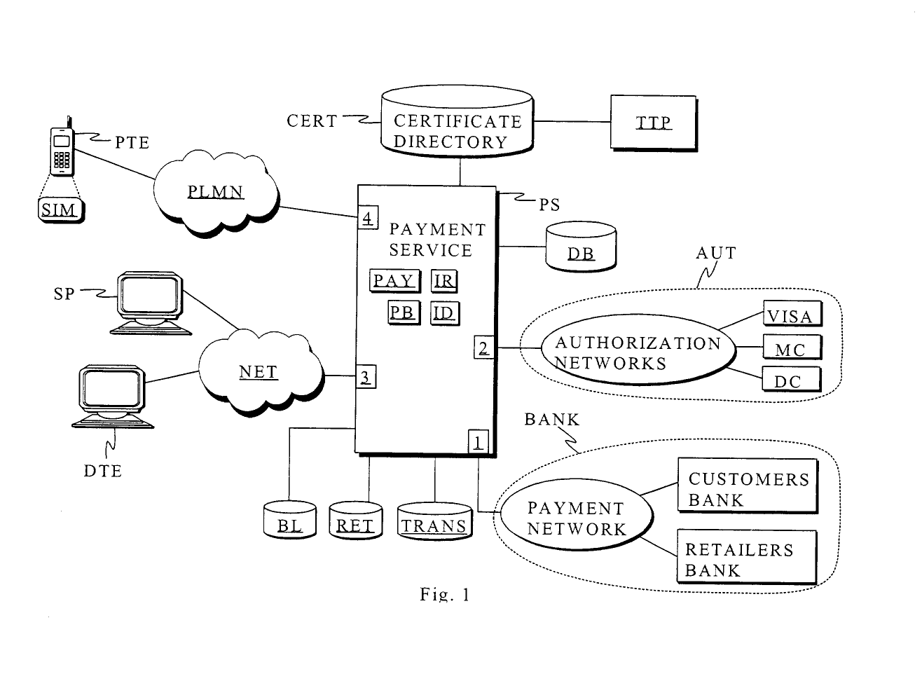

The inventive apparatus or system shown in FIG. 1 includes payment service equipment PS to which is connected five different databases: a client database DB, a service provider database RET, a transaction database TRANS, a verification database BL and a certificate database CERT. The client database DB contains information relating to the clients and may, by way of illustrative example, include for each client the client's name, address, identity number, mobile number and an item or piece of information associated with each of the client's payment cards. The service provider database RET contains information about registered service providers, such as the IP (Internet Protocol) address of the service provider, the payment cards accepted by the service provider, and the bankers of the service provider.

The transaction database TRANS stores vouchers for the orders of products or services that have been made via the payment service equipment PS. The transaction database TRANS is responsible for providing voucher storage to enable, if and as necessary, subsequent review and verification of purchases that have previously been made. The verification database BL functions to save information about suspicious payment cards, and thereby provides a manner of payment card blacklist. The certificate database CERT stores certificates generated for the clients and those certificates typically include, for example, information relating to the client and to the issuer of the certificate, such as the client's name, identity number, address, public key, and electronic identity. The certificate is issued by a trusted third party TTP, such as a certificate authority, which also updates the certificate database CERT to keep current its storage of issued certificates.

In the embodiment of the invention shown in FIG. 1, the system comprises four access interfaces: a first access interface 1 to the payment system BANK, a second access interface 2 to the authentication system AUT, a third access interface 3 to the telecommunication network NET, and a fourth access interface to the mobile communication network PLMN. These various systems, databases and networks are connected to the payment service equipment PS via the relevant access interfaces. By way of illustrative example, the mobile communication network PLMN may be a mobile communication network consistent with the GSM protocols. Similarly, the telecommunication network NET may be a packet-switched data transmission network such as the Internet or, alternatively, any other packet-switched data transmission network.

The payment service equipment PS further comprises a generation block PAY for generating a billing ticket associated with each payment transaction. The telecommunication block PB functions to send and receive a confirmation of order associated with each billing ticket. The identification block ID identifies the client based on the electronic identity and/or digital signature. The information retrieval block IR determines the payment card information that relates to the client seeking to make a purchase.

Connected to the mobile communication network PLMN is at least one, and generally a large multiplicity of, payment terminal devices PTE, as for example mobile stations. A smart card SIM, such as a subscriber identity module, is connected to the mobile station PTE. Stored on the subscriber identity module SIM are, by way of example, the electronic identity associated with the holder or owner of the subscriber identity module SIM, the holder's private key, and the public key associated with the payment service equipment. The private key may be a private key consistent with the PKI system.

Connected to the network NET are a service provider SP and a display terminal device DTE. The service provider SP is an entity that offers to clients the opportunity to effect purchases via the telecommunication network NET. These purchases are debited from a client account or the like by means of the client's payment card. The display terminal device DTE may be an ordinary personal computer having the necessary facilities and devices for using or receiving a service offered by the service provider PS.

Also connected to the payment service equipment PS is the authentication system AUT by means of which the payment service equipment may check the validity of the client's payment cards. In this particular example, the authentication system AUT comprises relevant or appropriate data transmission networks, through each of which the payment service equipment PS has access to information systems of each company offering or sponsoring a payment card.

Also connected to the payment service equipment PS is the payment system BANK, such as a system that actually debits the appropriate payment sum from the client's payment card account or the like and correspondingly credits the same sum to the account of the service provider SP.

The payment service equipment PS may, when required, be separated from the telecommunication network NET by a firewall, i.e. a software or hardware configuration that functions to prevent unauthorized access by extraneous entities to the resources of a company or to the resources of one's own telecommunication network.

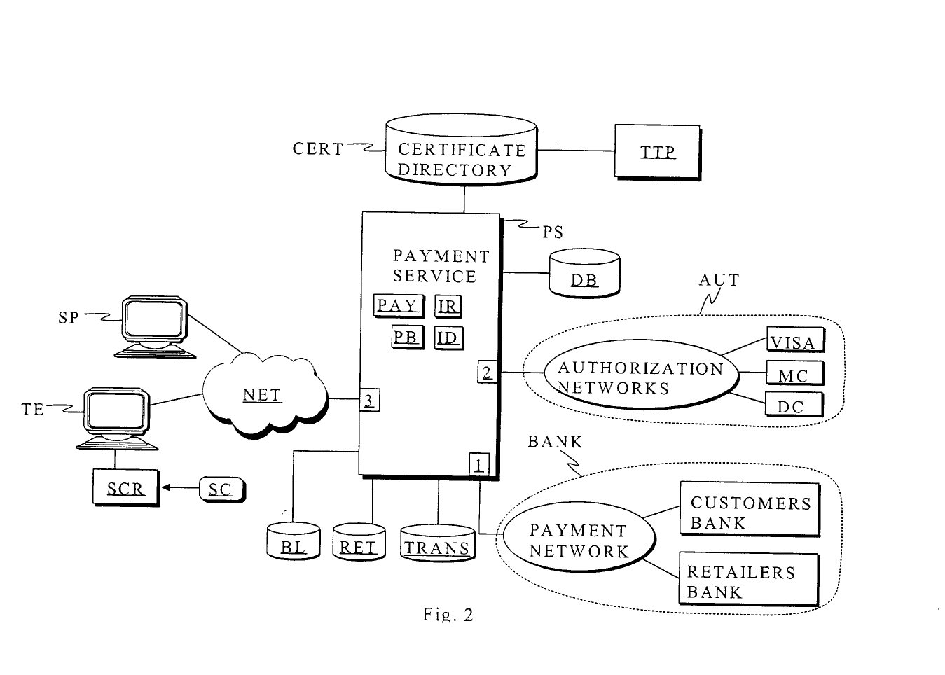

The inventive system shown by way of further example in FIG. 2 includes payment service equipment PS to which are connected five different databases: a client database DB, a service provider database RET, a transaction database TRANS, a verification database BL and a certificate database CERT. The client database DB contains information relating to the clients, such for example as each client's name, address, identity number, mobile number and a piece of information related to or associated with each of the client's payment cards. The service provider database RET contains information about registered service providers, such as the IP address of the service provider, the payment cards accepted by the service provider, and the bankers of the service provider. Stored in the transaction database TRANS are vouchers of the orders for products and/or services that have been effected via the payment service equipment PS. The transaction database TRANS provides a voucher storage facility that enables, if necessary, subsequent unambiguous verification of previously-made and recorded purchases. The verification database BL stores information about suspicious payment cards, thus functioning as a kind of blacklist of such cards. The certificate database CERT stores certificates generated for the clients and that typically include information relating to the client and to the issuer of the certificate, such for example as the client's name, identity number, address, public key, and electronic identity. These certificates are issued by the trusted third party TTP, such as a certificate authority, which also updates the certificate database CERT.

In the FIG. 2 embodiment the payment service equipment includes three access interfaces: a first access interface 1 to the payment system BANK, a second access interface 2 to the authentication system AUT, and a third access interface 3 to the telecommunication network NET. These systems and the telecommunication network NET are connected to the payment service equipment PS via the relevant access interfaces. The telecommunication network NET may for example be a packet-switched data transmission network such as the Internet, or any other packet-switched data network.

The payment service equipment PS additionally includes a generation block PAY for generating the billing tickets associated with payment transactions. The telecommunication block PB is operable for sending and receiving confirmations of orders associated with the billing tickets. An identification block ID identifies the client for a transaction based on the electronic identity and/or digital signature, and an information retrieval block IR identifies the payment card information associated with the client.

Connected to the telecommunication network NET are the service provider SP and the terminal device TE. The service provider SP is an entity that offers the clients an opportunity to make purchases via the telecommunication network NET. Such purchases are debited from the payment card or account of the client. The terminal device TE may be an ordinary personal computer that includes the necessary or appropriate facilities and devices for using the service offered by the service provider SP. A smart card reader SCR, into which a smart card of the client is insertable, is connected to the terminal device TE. The smart card SC may contain, stored thereon, the electronic identity associated with the holder of the smart card SC, the private key of the holder, and the public key associated with the payment service equipment. The private key may be one consistent with PKI protocols. The card reader SCR may alternatively comprise a device or facility that is internally installed in the terminal device TE.

Connected to the payment service equipment PS is an authentication system AUT for use in checking the validity of the client's payment cards and which may comprise relevant data transmission networks. Via such data transmission networks the payment service equipment PS is provided with access to the information system of each company that offers or issues or supports a payment card.

Also connected to the payment service equipment PS is a payment system BANK, which is generally a system that actually debits the client's payment card account or the like and correspondingly credits the account of the service provider SP with the same sum.

The payment service equipment PS may, when appropriate or required, be separated from the telecommunication network NET by a firewall. Such a firewall may be implemented by a suitable software or hardware configuration operative to prevent unauthorized access by extraneous entities to the resources of a company or system.

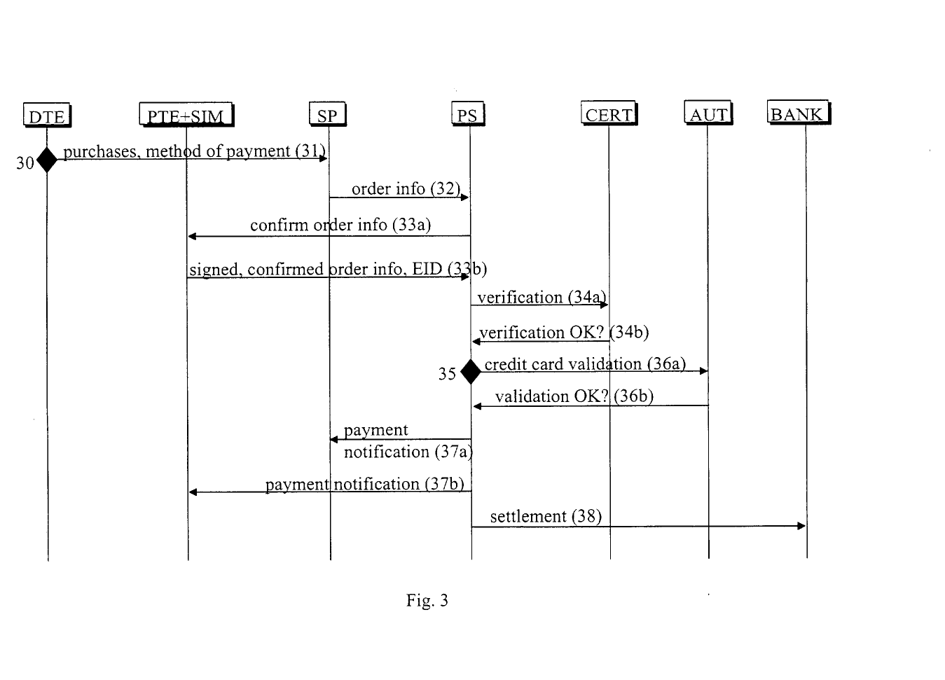

The flow chart of FIG. 3 depicts the functionality of one advantageous implementation of the invention. In this illustrative embodiment the system includes a display device DTE, a payment terminal device PTE, a smart card SIM inserted into the payment terminal device PTE, a service provider SP, payment service equipment PS, a certificate database CERT, an authentication system AUT, and a payment system BANK. The display terminal device DTE may be an ordinary personal computer or the like, the payment terminal device PTE may be a mobile station, and the smart card SIM may be a subscriber identity module of the mobile station.

The rhombus 30 in FIG. 3 is used to indicate the actions that the client takes via the computer DTE. In this example, the client chooses the World Wide Web (WWW) site associated with the service offered by the service provider SP. The service may require a registration and, in registering for the service, the client transmits information about himself/herself to the service provider SP. That information may for example include the client's name, address, and mobile number. The access to the WWW site for accessing or using the service may require that the client input a client identifier and a password. In addition, the client has obtained a certificate issued by a trusted third party, and the certificate has been saved to the certificate database of the payment service equipment PS. The payment service equipment PS may include a database which comprises all of the service providers that have contracted for use of the payment service equipment PS in connection with the services offered by the service providers. The service provider database may for example include information about the payment cards accepted by each service provider and about the bankers of each service provider. The information stored in the service provider database may if appropriate or required be encrypted, as with the public key of the payment service equipment.

The arrow 31 in FIG. 3 is used to now describe the information which the client transmits to the service provider SP via the WWW site. The client is assumed to have selected the desired products and/or services via the WWW site of the service provider SP and, in addition, has chosen the desired payment mode, which in this particular example is a Visa card. The client may be requested to additionally provide or fill in his or her mobile number on the order form. When all of the necessary information has been filled in or selected, the client transmits the order, as by clicking on or selecting the “pay” button on the WWW site. As a consequence of thereby selecting or otherwise activating the pay button, the WWW site produced by the payment service equipment may be displayed for the client.

The service provider SP then transmits the information received from the client to the payment service equipment PS (arrow 32). The service provider SP may also send to the payment service equipment PS information that the client/user has not directly input to the WWW site, such as the mobile number that was included in the client's registration information, the name or identifier of the service provider SP, the total sum of the products or services ordered, and the current date. The information transmitted by the service provider SP to the payment service equipment PS may be encrypted, if appropriate or required, or a check sum may be computed and sent, as for example using a hash function that generates an individual check sum from a given input, to thereby provide the ability to confirm the integrity of the information transmitted. This encryption or generation of a check sum is not, however, absolutely necessary since the information transmitted at this point by the service provider SP is not itself sensitive. It should also be pointed out that the service provider SP does not at any point transmit, to the payment service equipment PS, more detailed information relating to the payment card of the client, such as the card number or its validity. With respect to the client's payment card, the service provider SP may send to the payment service equipment PS only that piece of information which identifies the payment card company, i.e. that the payment card is for example a Visa, MasterCard, Diners Club, or bank card.

The payment service equipment PS then sends a confirmation of the order to the mobile station PTE of the client, for example as a short message based on the information received from the service provider SP (arrow 33a). The confirmation of order includes information relating to the order that the client has placed, such as the date, the products and/or services ordered, the total sum owed, etc. The client checks the information contained in the confirmation of order and, if it is found to be correct, the client digitally signs the confirmation of order with his or her private signing key. The electronic identity associated with the holder and the private key of the holder may be stored in the subscriber identity module SIM. The private key may be one consistent with PKI systems. The digital signing of the confirmation of order using the mobile station may also require that the client first input to the mobile station a predetermined code, such as a PIN (Personal Identification Number) code.

In addition to the confirmation of order, the client sends to the payment service equipment his or her electronic identity from the client's mobile station PTE (arrow 33b). The payment service equipment PS receives the information sent from the mobile station PTE and checks the digital signature of the client in the certificate database CERT that is connected to the payment service equipment PS (arrows 34a and 34b). Only the payment service equipment PS has the right to read the certificate database CERT. The payment service equipment PS further authenticates the client's signature and electronic identity, as by utilizing the client database.

When the client's identity has been verified, the payment service equipment PS determines the credit card number of the client. This functionality is indicated in FIG. 3 by rhombus 35. The payment card number is identified, as for example in the client database that is attached or connected to or associated with the payment service equipment PS. The information stored in the client database has been encrypted using the public key of the payment service equipment PS, so that only the payment service equipment PS can decode that encrypted information into a readable form by using the private key of the payment service equipment PS. The client's payment card number may alternatively be stored in the client-specific certificate that is stored in the certificate database CERT.

When the payment service equipment PS has determined the client's payment card number, the payment card number is sent to the authentication system AUT to be verified (arrow 36a). The authentication system AUT verifies that the card identified by the payment card number is valid, and then returns the result of the validity verification to the payment service equipment PS (arrow 36b).

The client payment for and associated with the client's order or purchase may now be effected. Optionally, the verification database attached to the payment service equipment PS can be consulted, prior to accepting the payment, to verify that the client's payment card is not among those identified in the verification database as suspicious or forbidden for use. In any event, the payment service equipment PS then sends a confirmation that payment has been effected to both the service provider SP and the client (arrows 37a and 37b). The command to effect the actual debiting or transfer of funds or the like with respect to the payment may now be sent to the payment system BANK (arrow 38). The payment system BANK debits the client's payment card account with the sum shown by the order, and correspondingly credits the account of the service provider SP with the same sum.

Vouchers for all of the orders that have been processed or completed may be stored in the transaction database that is attached to the payment service equipment PS. The data record that is stored in the database for each such transaction may by way of illustrative example include:

the electronic identity information of the client, the payment card details, the account number, and the client's name and address;

the total monetary sum or amount of the order;

the recipient;

the date;

the client's digital signature;

the authentication code; and

a time stamp that has been received from a certificate authority.

In the embodiment shown in FIG. 3, the payment service equipment PS may be configured so that the use of a particular payment card requires the use of a particular mobile number. This may be implemented so that, if the client wishes to pay for a purchases with, for example, a VISA card, the client must have a particular subscriber identity module SIM inserted into the client's mobile station.

Also in implementing the embodiment shown in FIG. 3, the payment terminal device PTE and the display device DTE may physically comprise the same device, such as (as is preferred) the client's mobile station.

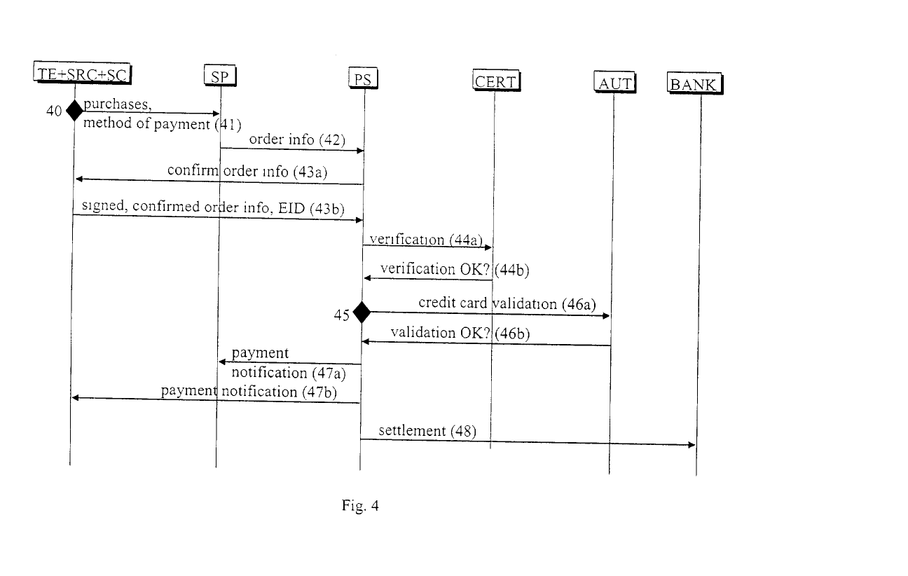

The flow chart of FIG. 4 depicts the functionality and operation of another embodiment of the invention. The embodiment shown in FIG. 4 includes a terminal device TE, a card reader SRC attached to the terminal device with an associated compatible smart card SC inserted or insertable therein, a service provider SP, payment service equipment PS, a certificate database CERT, an authentication system AUT, and a payment system BANK. The terminal device TE is, in this embodiment, a personal computer or the like.

The rhombus 40 in FIG. 4 is used to indicate the actions that the client takes via the computer TE. The client selects the WWW site associated with or for accessing the service being offered by the service provider SP. That service may require registration and, in registering for the service, the client transmits information about him or herself to the service provider SP. Such information may for example include the client's name, address and mobile number. Access to the WWW site(s) required by the service may also require that the client first input a client identifier and a password. In addition, the client will have received a certificate that has been issued by a trusted third party, and that certificate will have been stored for access by the payment service equipment PS, such as in the certificate database of the payment service equipment. The payment service equipment PS illustratively includes a database that identifies all of the service providers that have contracted for use of the payment service equipment PS, and this service provider database may additionally include information about the payment cards accepted by each service provider and about the bankers of each service provider. The information stored in the service provider database may if appropriate or required be encrypted, as for example using the public key of the payment service equipment.

Arrow 41 in FIG. 4 represents the information that the client transmits to the service provider SP via the WWW site, i.e. the products and/or services that the client has selected for purchase via the www site of the service provider. The client also selects the desired payment mode, in this example a Visa card. The client may also be requested to additionally enter the client's mobile number on the purchase request form. When all of the necessary information has been entered or selected, the client transmits the order, as by clicking on or selecting the pay button on the WWW site, in response to which the WWW site of the payment service equipment may then be displayed.

The service provider SP then transmits the information received from the client to the payment service equipment PS (arrow 42). The service provider SP may also send to the payment service equipment PS information that the user has not directly input to the WWW site in placing the order or purchase request, such for example as the mobile number provided by the client in registering for the service, the name or identifier of the service provider SP, the total sum of the products or services ordered, and the date. The information thus transmitted by the service provider SP to the payment service equipment PS may be encrypted, or a checksum may be computed using, for example, a hash function that generates an individual check sum from a given input, thereby enabling enhanced certainty of the integrity of the information sent. The encryption or generating of a check sum is not, however, absolutely necessary because the information thus sent by the service provider SP is not itself particularly sensitive. It should also be noted that at no point does the service provider SP send to the payment service equipment PS more detailed information relating to the payment card of the client, such as the card number or its validity. As concerns the client's payment card, the service provider SP may send to the payment service equipment PS only information concerning the payment card company, i.e. that the payment card is, by way of example, a Visa, MasterCard, Diners Club or bank card.

The payment service equipment PS then transmits a confirmation of order, containing information relating to the client's order, to the terminal device TE of the client based on the information received from the service provider SP (arrow 43a). The transmitted information may include the date, the products and/or services ordered, the total sum, etc. The client checks the information contained in the confirmation of order and, if it is found to be correct, the client signs the confirmation of order with the client's private signing key. That digital signing is carried out using the card reader SCR attached to the computer TE and the client's inserted smart card. Stored on the smart card SC are the electronic identity associated with the holder of the smart card and the private key of the holder, which may for example be consistent with the PKI system. Digital signing using the terminal device TE and card reader SCR may also require that the client first input to his or her mobile station a predetermined code such as a PIN (Personal Identification Number) code.

In addition to the confirmation of order, the client sends from his or her mobile station PTE to the payment service equipment PS the client's electronic identity (arrow 43b). The payment service equipment PS receives the information sent by the mobile station PTE (or computer TE) and verifies the signature of the client against the certificate database CERT which is attached to the payment service equipment PS (arrows 44a and 44b). Only the payment service equipment PS has the right to read the certificate database CERT. The payment service equipment PS further authenticates the client's signature and electronic identity, as by utilizing the client database.

When the client's identity has been verified, the payment service equipment PS determines the credit card number of the client. This functionality is indicated by the rhombus 45 in FIG. 4. The payment card number is identified, such as in the client database attached to the payment service equipment PS. The information stored in the client database has been encrypted with the public key of the payment service equipment PS so that only the payment service equipment PS can decode the encrypted information stored in the client database into a readable form by using the private key of the payment service equipment. The client's payment card number may alternatively be contained in the client-specific certificate that is stored in the certificate database CERT.

When the payment service equipment PS has determined the client's payment card number, it is sent to the authentication system AUT to be verified (arrow 46a). The authentication system AUT verifies that the card identified by the payment card number is valid, and then returns the result of the validity check back to the payment service equipment PS (arrow 46b).

The payment associated with the order placed by the client may now be effected or completed. Prior to accepting the payment, the verification database attached to the payment service equipment PS may be consulted to confirm that the client's payment card is not among those identified as suspicious or forbidden for use. The payment service equipment PS then sends a confirmation that payment has been effected to both the service provider SP and the client (arrows 47a and 47b). The command or instruction to effect the payment may now be transmitted to the payment system BANK (arrow 48), which debits the client's payment card account or the like for the sum indicated by the order and correspondingly credits the account of the service provider SP for the same sum.

Vouchers for all of the orders that have been placed or completed may be stored to the transaction database attached to the payment service equipment PS. The transaction data record stored in the database may for example include:

the electronic identity information of the client, the payment card details, the account number, and the client' sname and address;

the total sum of the order;

the recipient;

the date;

the client's signature;

the authentication code; and

a time stamp that has been received from the certificate authority;

While there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Payment service equipment operable for completing online payment transactions using a client payment card, comprising:
a first access interface for connection to a payment system;
a second access interface for connection to an authentication system;
a third access interface for connection to a telecommunication network;
a certificate database for storing certificates associated with clients;
a service provider database for storing information relating to registered service providers from which the clients can purchase goods and services in online transactions;
a client database for storing information relating to the clients, said information relating to the clients comprising, for each client, at least one of a client mobile number and information relating to the payment card of the each client;
a transaction database for storing information relating to the payment transactions;
a verification database for storing a listing of suspicious payment cards;
a generation block for generating billing tickets associated with the payment transactions;
a telecommunication block for sending and receiving a confirmation of order associated with a payment transaction;
an identification block for identifying a client based on an electronic identity and digital signature of the client;
an information retrieval block for determining payment card information for the clients; and
a fourth access interface for connection between the payment service equipment and the mobile communication network.

2. Payment service equipment in accordance with claim 1, wherein the payment card is a credit card.

3. Payment service equipment in accordance with claim 1, wherein the information stored in one of the client database and the service provider database is encrypted.

4. Payment service equipment in accordance with claim 1, wherein payment card information is included in the certificates stored in the certification database.

5. A method for secure online payment in a telecommunication system that includes a mobile communication network, a telecommunication network, a payment terminal device connected to the mobile communication network and that includes a smart card, a display terminal device connected to one of the mobile communication network and the telecommunication network, a trusted third party, a payment system, a service provider, and an authentication system, said method comprising the steps of:
generating and issuing, by the trusted third party, a certificate associated with a client;
selecting, and thereby ordering from the service provider by the client, one of a product and a service using the terminal display device via one of the telecommunication network and the mobile communication network;
using one of a payment card of the client and client payment card information to pay for the ordered one of a product and a service;
generating, by payment service equipment, a billing ticket associated with the ordered one of a product and a service;
sending a confirmation of order associated with the ordered one of a product and a service to the payment terminal device of the client via the mobile communication network for receipt by the client;
at least one of digitally signing and encrypting the received confirmation of order using the payment terminal device of the client;
sending the at least one of digitally signed and encrypted confirmation of order and electronic identity information associated with the client from the payment terminal device of the client to the payment service equipment via the mobile communication network;
identifying the client at the payment service equipment based on the at least one of the digital signature and the encryption of the confirmation of order sent from the payment terminal device of the client;
retrieving a number of the client payment card based on the at least one of the digital signature and the encryption of the confirmation of order sent from the payment terminal device of the client to the payment service equipment; and
verifying a right of use of the client payment card and, if the verification is successful, accepting payment for the ordered at least one of goods and services.

6. The method of claim 5, wherein the client is identified at the payment service equipment based on information contained in a certification database connected to the payment service equipment.

7. The method of claim 5, wherein the client payment card number is retrieved from a client database of the payment service equipment.

8. The method of claim 5, wherein the client payment card number is retrieved from a certification database connected to the payment service equipment.

9. The method of claim 5, further comprising the step of verifying validity of the client payment card in the authentication system.

10. The method of claim 5, further comprising the step of verifying in a verification database connected to the payment service equipment that the client payment card is not among suspicious and forbidden cards listed in the verification database.

11. The method of claim 5, further comprising the step of verifying validity of the client payment card in the authentication system, and wherein said accepting payment comprises sending to the payment system, after said verifying validity of the client payment card, a request for debiting of the payment from a payment card account of the client.

12. The method of claim 5, further comprising the step of sending, to one of the display terminal device of the client and the payment terminal device of the client, and to the service provider, a confirmation that an order has succeeded.

13. The method of claim 6, wherein the certificate database is updated by the trusted third party.

14. The method of claim 5, wherein the payment terminal device and the display terminal device comprise a mobile station.

15. The method of claim 5, wherein the payment terminal device comprises a mobile station and the display terminal device comprises a personal computer.

16. The method of claim 5, wherein the client payment card comprises one of a Visa card, a Mastercard card, a Diners Club card and a bank card.

17. The method of claim 5, wherein the smart card comprises a subscriber identity module.

18. The method of claim 5, wherein the smart card contains, stored on the smart card, the electronic identity information of the client and a private key of the client.

19. The method of claim 5, wherein the smart card contains, stored on the smart card, a public key associated with the payment service equipment.

20. The method of claim 5, wherein the mobile communication network comprises a GSM mobile communication network.

21. The method of claim 5, wherein the telecommunication network comprises a packet-switched network.

22. A method for secure online payment in a telecommunication system that includes a telecommunication network, a terminal device connected to the telecommunication network and to which is attached a card reader for receiving a smart card, a trusted third party, a payment system, a service provider, and an authentication system, said method comprising the steps of:
generating and issuing, by the trusted third party, a certificate associated with a client;
selecting, and thereby ordering from the service provider by the client, one of a product and a service using the terminal display device via the telecommunication network;
using one of a payment card of the client and client payment card information to pay for the ordered one of a product and a service;
generating, by payment service equipment, a billing ticket associated with the ordered one of a product and a service;
sending a confirmation of order associated with the ordered one of a product and service to the terminal device of the client via the telecommunication network;
at least one of signing and encrypting the received confirmation of order using the smart card in the card reader attached to the terminal device of the client;
sending the at least one of signed and encrypted confirmation of order and electronic identity information associated with the client from the terminal device to the payment service equipment via the telecommunication network;
identifying the client at the payment service equipment based on the at least one of the digital signature and the encryption of the confirmation of order sent from the terminal device of the client;
retrieving a number of the client payment card based on the at least one of the digital signature and the encryption of the confirmation of order sent from the terminal device of the client to the payment service equipment; and
verifying a right of use of the client payment card and, if the verification is successful, accepting payment for the ordered at least one of goods and services.

23. The method of claim 22, wherein the client is identified at the payment service equipment based on information contained in a certification database connected to the payment service equipment.

24. The method of claim 22, wherein the client payment card number is retrieved from a client database of the payment service equipment.

25. The method of claim 22 wherein the client payment card number is retrieved from a certification database connected to the payment service equipment.

26. The method of claim 22, further comprising the step of verifying validity of the client payment card in the authentication system.

27. The method of claim 22, further comprising the step of verifying in a verification database connected to the payment service equipment that the client payment card is not among suspicious and forbidden cards listed in the verification database.

28. The method of claim 22, further comprising the step of verifying validity of the client payment card in the authentication system, and wherein said accepting payment comprises sending to the payment system, after said verifying validity of the client payment card, a request for debiting of the payment from a payment card account of the client.

29. The method of claim 22, further comprising the step of sending, to the terminal device of the client and to the service provider, a confirmation that an order has succeeded.

30. The method of claim 23, wherein the certificate database is updated by the trusted third party.

31. The method of claim 22, wherein the terminal device comprises a personal computer.

32. The method of claim 22, wherein the client payment card comprises one of a Visa card, a Mastercard card, a Diners Club card, and a bank card.

33. The method of claim 22, wherein the smart card contains, stored on the smart card, the electronic identity of the client and a private key of the client.

34. The method of claim 22, wherein the smart card contains, stored on the smart card, a public key associated with the payment service equipment.

35. The method of claim 22, wherein the telecommunication network comprises a packet-switched network.
